(19) United States
(12) Patent Application Publication
(10) Pub. No.: US 2017/0136988 A1
(43) Pub. Date: May 18, 2017

(54) VALET PARKING SECURITY SYSTEM FOR A MOTOR VEHICLE

(71) Applicant: FORD GLOBAL TECHNOLOGIES, LLC, Dearborn, MI (US)

(72) Inventors: Juan Francisco Alvarado Leon, Mexico City (MX); Nestor Eduardo Rueda Don Juan, Naucalpan (MX)

(21) Appl. No.: 14/939,541

(22) Filed: Nov. 12, 2015

(51) Int. Cl. B60R 25/01; E05B 41/00; E05B 77/00; E05B 83/32; E05B 81/04; E05B 83/18; E05B 83/30; B60R 25/23; E05B 79/10

(52) U.S. Cl. CPC B60R 25/01; B60R 25/23; E05B 41/00; E05B 77/00; E05B 79/10; E05B 81/04; E05B 83/18; E05B 83/30; E05B 83/32; E05B 2047/0048

(57) ABSTRACT

A valet parking security system is provided for a motor vehicle. That valet parking security system includes an electronic trunk latch, a supplemental trunk access latch, such as a folding seat latch or a pass-through door latch, and a controller. The controller is configured to lock the electronic trunk latch and the supplemental trunk access latch when in a valet parking mode.

### TECHNICAL FIELD

This document relates generally to the motor vehicle equipment field and, more particularly, to a valet parking security system for a motor vehicle.

### BACKGROUND

Many clubs, restaurants, theaters, malls and special social events offer valet parking. It is a convenience that many vehicle owners desire to use. However, most of the time personal belongings such as sunglasses, electronic music devices, tablets and laptops, money, luggage, groceries, tools and other items are left inside the vehicles. In these situations the owner desires to have such valuable items held in a secure manner away from access by the valet parking attendant or any other individual while the motor vehicle is valet parked. This need for security extends to under hood mechanical items and the spare tire.

This document relates to a new and improved valet parking security system for a motor vehicle that maximizes the available security for personal items left inside the motor vehicle while the motor vehicle is operated in valet parking mode.

### SUMMARY

In accordance with the purposes and benefits described herein, a valet parking security system is provided for a motor vehicle. That valet parking security system comprises an electronic trunk latch, a supplemental trunk access latch and a controller configured to lock the electronic trunk latch and the supplemental trunk access latch when in a valet parking mode.

In one possible embodiment, the valet parking security system further includes a human interface. In one possible embodiment, that human interface is a touch screen.

In one possible embodiment, the controller is configured to display a valet parking security system message on the touch screen when the valet parking security system is in the valet parking mode. That valet parking security system message may include at least one parameter selected from a group of parameters consisting of average vehicle speed, maximum vehicle speed, maximum vehicle rpm and engine run time since the valet parking mode was engaged.

Further the valet parking security message may also include a distance travelled indication since the valet parking mode was engaged. In another possible embodiment, the valet parking security message includes a maximum volume of the motor vehicle audio system since the valet parking mode was engaged. In yet another possible embodiment, the valet parking security message includes a record of any attempt to open a secured compartment of the motor vehicle since the valet parking mode was engaged.

For motor vehicles equipped with a folding rear seat between the passenger cabin and the trunk area, the supplemental trunk access latch is a folding rear seat latch. For motor vehicles equipped with a pass-through door between the passenger cabin and the trunk area, the supplemental trunk access latch is a pass-through door latch.

The valet parking security system may also include an electronic hood latch. In such an embodiment the controller is configured to lock the electronic hood latch when in the valet parking mode.

The valet parking security system may also include an electronic glove box latch. In such embodiments, the controller is configured to lock the electronic glove box latch when in the valet parking mode.

Still further, where the motor vehicle is equipped with a locking center console storage bin, the valet parking security system may include an electronic center console latch. In such embodiments, the controller is configured to lock the electronic center console latch when in the valet parking mode.

In the following description, there are shown and described several preferred embodiments of the valet parking security system. As it should be realized, the valet parking security system is capable of other, different embodiments and its several details are capable of modification in various, obvious aspects all without departing from the valet parking security system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the valet parking security system and together with the description serve to explain certain principles thereof. In the drawing figures:

FIG. 1 is schematic block diagram of the valet parking security system.

FIG. 2 is a schematic block diagram of the controller for the valet parking security system.

FIG. 3 is a front elevational view of a touch screen of the valet parking security system illustrating the valet parking security system message displayed on that screen when the valet parking mode has been activated.

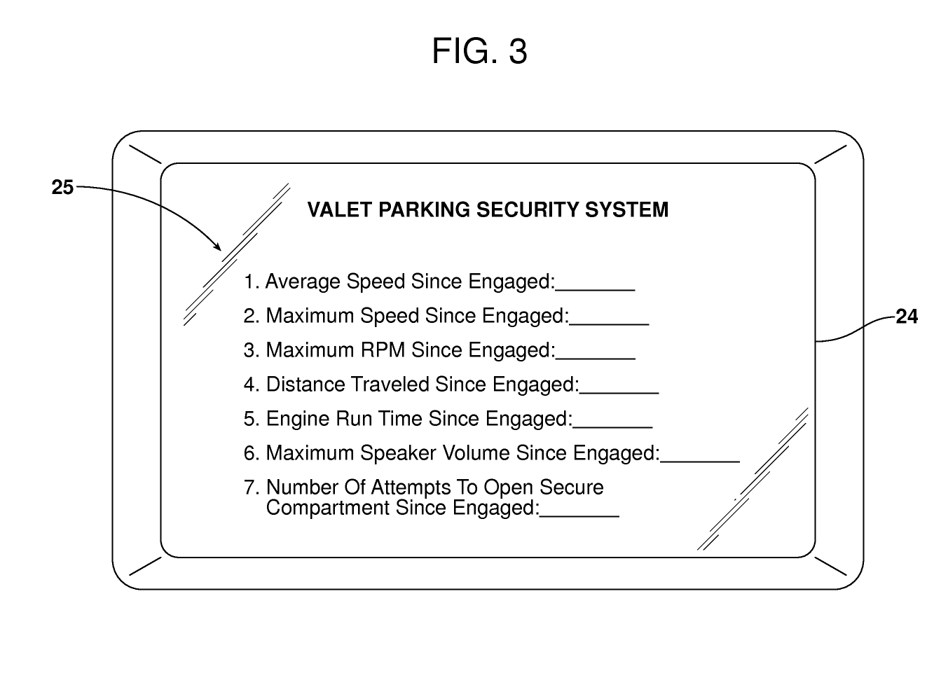

FIG. 4 summarizes the initial configuration and functionality of the security system.

Reference will now be made in detail to the present preferred embodiments of the valet parking security system, examples of which are illustrated in the accompanying drawing figures.

### DETAILED DESCRIPTION

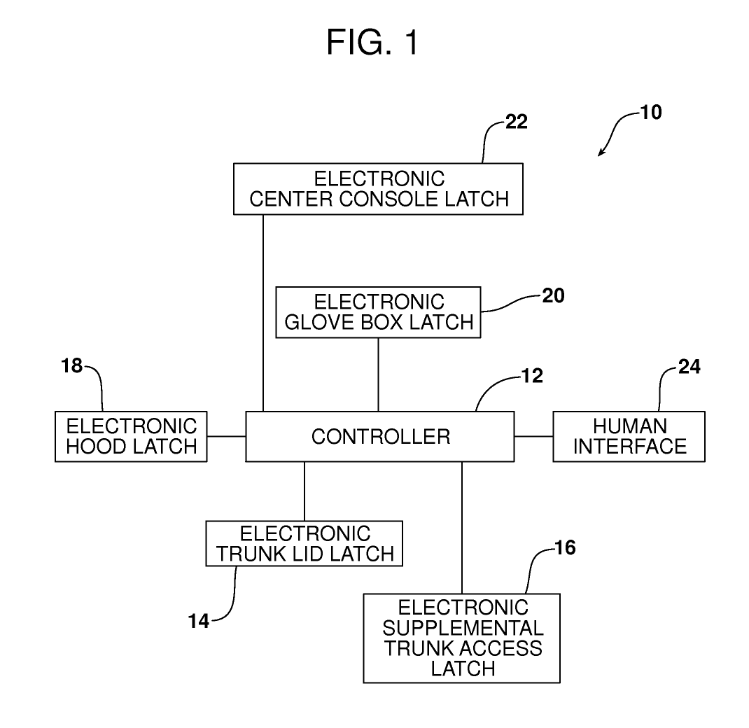

Reference is now made to FIG. 1 illustrating the valet parking security system 10 that is the subject matter of this document. That valet parking security system 10 includes a controller 12 that is connected to various electronic latches 14-22 and a human interface 24. Those electronic latches 14-22 include an electronic trunk lid latch 14 for securing the trunk lid of the motor vehicle in a locked state, an electronic supplemental trunk access latch 16 for securing supplemental trunk access in a locked state, an electronic hood latch 18 for securing the motor vehicle hood in a locked state, an electronic glove box latch 20 for securing the glove box door in a locked state, and an electronic center console latch 22 for securing the access door to any center console storage bin of the motor vehicle in a locked state. As will be apparent from the following description, the human interface 24 may comprise a touch screen display if desired.

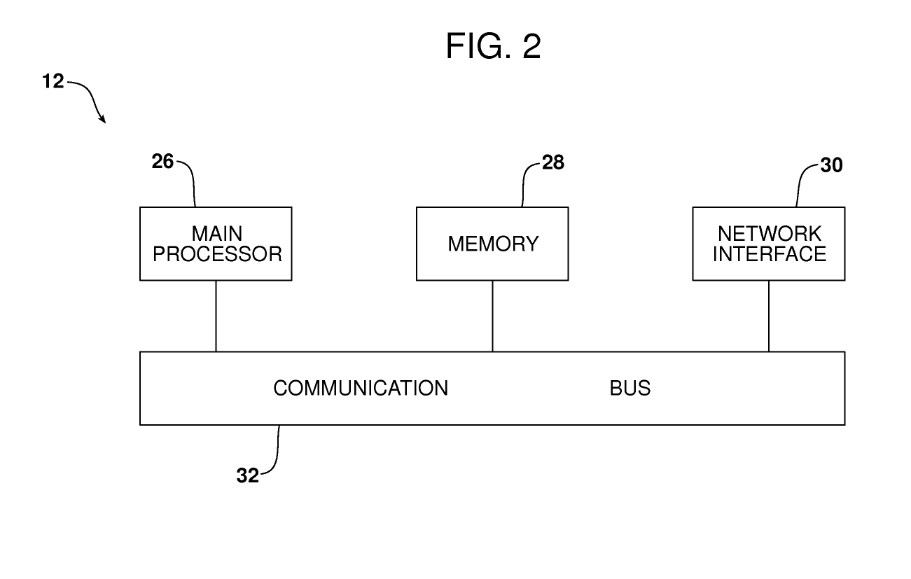

As illustrated in FIG. 2, the controller 12 may comprise one or more processors 26, one or more memories 28, and one or more network interfaces 30. As should be appreciated all of these components 26, 28 and 30 communicate with each other over a communication bus 32. In one possible embodiment the controller 12 comprises a computing device such as a dedicated microprocessor or an electronic control unit (EC) operating under appropriate software instructions.

When the vehicle operator desires to relinquish control of his motor vehicle to a valet parking attendant, the operator may activate the valet parking mode of the valet parking security system 10 by depressing an appropriate dedicated switch or touching a designated point on the human interface/touch screen 24. When activated, the controller 12 either directly or through another controller such as the body control module (BCM) (not shown) of the motor vehicle locks the various electronic latches 14-22 of the motor vehicle. Thus, the trunk lid of the motor vehicle is locked by means of the electronic trunk lid latch 14. Where the motor vehicle is equipped with folding rear seats, the electronic supplemental trunk access latch 16 locks those folding rear seats in the upright position thereby preventing access to the trunk area by means of folding the rear seats down. Where the motor vehicle includes a pass-through door between the passenger cabin and the trunk area, the electronic supplemental trunk access latch 16 locks the pass-through door in the closed position thereby denying access to the trunk area through the pass-through door.

In those embodiments of the valet parking security system 10 including an electronic hood latch 18, the electronic hood latch is activated to lock the motor vehicle hood in a closed position thereby preventing access to the engine compartment of the motor vehicle. In this situation, it should be appreciated that one cannot bypass the security system 10 by cutting the current from the battery as the battery is secure under the locked hood. In those embodiments of the valet parking security system 10 incorporating an electronic glove box latch 20, the electronic glove box latch is activated to lock the glove box door thereby preventing access to the glove box and the contents contained therein. Further, in those embodiments of the valet parking security system 10 incorporating the electronic center console latch 22, that latch is locked to prevent access to the storage bin of the center console. This security system is effected to prevent access to the secure compartment areas of the motor vehicle even though the valet attendant may be given a key. This heightened level of security is maintained until the operator returns to the vehicle and deactivates the valet parking mode by, for example, a fingerprint reading on the touch screen 24 or by entry of an access code on the touch screen.

As a further security measure, when the valet mode is activated, the controller 12 displays a special valet parking security system message 25 on the touch screen display 24 which may, for example, be located in the center stack of the motor vehicle. That message may include any one or all of the indicated parameters including: average motor vehicle speed since the valet parking mode was engaged, maximum vehicle speed since the valet parking mode was engaged, maximum motor vehicle RPM since the valet parking mode was engaged, distance travelled by the motor vehicle since the valet parking mode was engaged, engine run time for the motor vehicle since the valet parking mode was engaged, maximum speaker volume since the valet parking mode was engaged, and number of attempts to open a secured compartment of the motor vehicle (trunk, hood, glove box door, center console storage bin, folding rear seats or pass-through door) since the valet parking mode was engaged. This running record and tabulation is displayed to the valet parking attendant in order to make him aware of a heightened security level for the motor vehicle and thereby discourage theft. Further, all information respecting the operation of the motor vehicle by the valet attendant in the absence of the vehicle owner is also displayed when the vehicle owner returns and receives his motor vehicle from the valet attendant. This added security and vehicle operating information provides the motor vehicle owner with peace of mind and greatly increases the satisfaction of vehicle ownership.

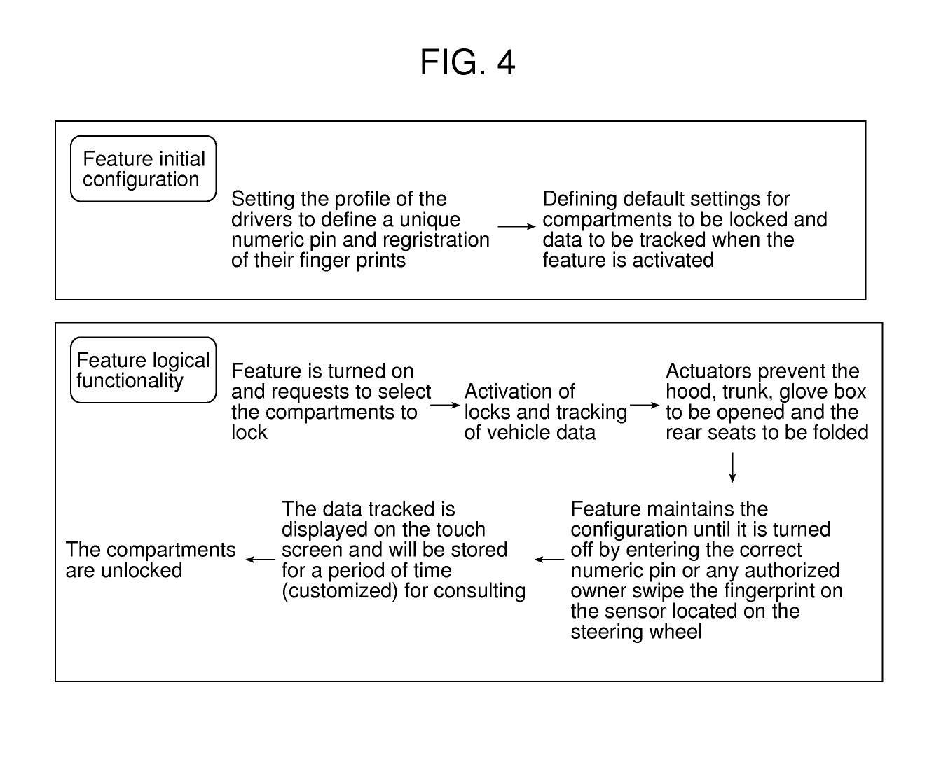

FIG. 4 summarizes the initial configuration and logical functionality of at least one embodiment of the valet parking security system 10.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A valet parking security system for a motor vehicle, comprising:
an electronic trunk latch; and
a supplemental trunk access latch;
a controller configured to lock said electronic trunk latch and said supplemental trunk access latch when in a valet parking mode.

2. The valet parking security system of claim 1 further including a human interface.

3. The valet parking security system of claim 2, wherein said human interface is a touch screen.

4. The valet parking security system of claim 3, wherein said controller is configured to display a valet parking security system message on said touch screen when said valet parking security system is in said valet parking mode.

5. The valet parking security system of claim 4, wherein said valet parking security system message includes at least one parameter selected from a group of parameters consisting of average vehicle speed, maximum vehicle speed, maximum vehicle RPM, and engine run time.

6. The valet parking security system of claim 4, wherein said valet parking security message includes distance travelled.

7. The valet parking security system of claim 4, wherein said valet parking security message includes volume of motor vehicle audio system.

8. The valet parking security system of claim 4, wherein said valet parking security system message includes record of any attempt to open a secure compartment of said motor vehicle.

9. The valet parking security system of claim 1, wherein said supplemental trunk access latch is a folding rear seat latch.

10. The valet parking security system of claim 9, further including an electronic hood latch, said controller being configured to lock said electronic hood latch when in said valet parking mode.

11. The valet parking security system of claim 10, further including an electronic glove box latch, said controller being configured to lock said electronic glove box latch when in said valet parking mode.

12. The valet parking security system of claim 11, further including a center console latch said controller being configured to lock said electronic center console latch when in said valet parking mode.

13. The valet parking security system of claim 9, further including an electronic glove box latch, said controller being configured to lock said electronic glove box latch when in said valet parking mode.

14. The valet parking security system of claim 9, further including a center console latch said controller being configured to lock said electronic center console latch when in said valet parking mode.

15. The valet parking security system claim 1, wherein said supplemental trunk access latch is a pass-through door latch for a pass-through door between a storage trunk and a passenger cabin of said motor vehicle.

16. The valet parking security system of claim 15, further including an electronic hood latch, said controller being configured to lock said electronic hood latch when in said valet parking mode.

17. The valet parking security system of claim 16, further including an electronic glove box latch, said controller being configured to lock said electronic glove box latch when in said valet parking mode.

18. The valet parking security system of claim 17, further including a center console latch said controller being configured to lock said electronic center console latch when in said valet parking mode.

19. The valet parking security system of claim 15, further including an electronic glove box latch, said controller being configured to lock said electronic glove box latch when in said valet parking mode.

20. The valet parking security system of claim 15, further including a center console latch said controller being configured to lock said electronic center console latch when in said valet parking mode.
